(19) United States
(12) Patent Application Publication
(10) Pub. No.: US 2004/0191376 A1
(43) Pub. Date: Sep. 30, 2004

(54) Process for extending shelf life of meat products

(76) Inventor: Lee Kramer, Memphis, TN (US)

Correspondence Address: Charles Y. Lackey, PO Box 5871, Winston-Salem, NC, 27113-5871, US

(21) Appl. No.: 10/394,963

(22) Filed: Mar. 24, 2003

(51) Int. Cl. C12C 3/04

(52) U.S. Cl. 426/412

(57) ABSTRACT

A method of treating sections of meat which includes forming them into desired shapes and placing them in impervious cook-in bags. The meat sections are cooked in the bags and then chilled down to a refrigerated state where they remain until sold or shipped. When shipment is needed, the meat sections are removed from the bags, exposed to a high velocity hot air treatment for a minimum of 10 seconds and thereafter packaged for use or shipment.

### BACKGROUND OF THE INVENTION

1. Field of the Invention

The present invention is a process for preserving meat products for an extended period of time, and more particularly to a process wherein meat segments are formed and shaped in a sealed vacuum cook-in bag of impervious material, cooked in the bag, stored in a refrigerated state, and exposed to a high velocity hot air treatment prior to final packaging and distribution.

2. Background of the Prior Art

Boneless hams processed for the delicatessen, food service and retail food markets are produced from muscles derived from boning commodity fresh hams. The price of bone-in commodity hams is subject to all the pressures normally associated with commodity marketing—supply and demand as well as seasonal variations. An economic opportunity arises if the processor can buy fresh bone-in commodity hams and process them into finished products and sell the finished product in the future when the ham market is considerably higher. The ability to capture this opportunity is limited to a relatively short interval due to the perishability of the product.

In conventional practice, meat processors form boneless hams from muscles or meat sections and shape them in either metal molds, plastic tubes, fibrous casings or knitted stockinets. The formed and shaped hams are typically heat processed in an oven (smokehouse). After the products reach an internal temperature of a minimum of 148 degrees F., the products are removed from the oven and chilled. After the products are chilled, they are packaged for distribution. The shelf life begins as soon as the product is chilled and normally does not extend beyond 90 days in a non-frozen state. The 90 day shelf life normally precludes the opportunity to capitalize on the variations of the fresh bone-in commodity ham market. As a secondary consideration, thermal heat processing ovens are a major capital investment, which at peak selling season, limits the processor's ability to satisfy demand.

In order to overcome the limitations of the prior art methods, it is desirable that a process for preserving meat be developed which permits the purchase of commodity hams when they are available in volume and at relatively low prices and the processing of these hams into a refrigerated inventory, which can be finished and sold to customers at times when commodity hams are low in availabilty and higher in price. This identified need also includes the formation of products made by the desired process with a shelf life of up to 9 months. It is to these needs that the present invention is directed.

### SUMMARY AND OBJECTIVES OF THE INVENTION

According to the present invention, a process for preserving meat includes forming and shaping boneless meat segments in commercially available smoke impregnated stockinets. After the meat products are shaped in the stockinets, they are loaded into a vacuum cook-in (Cry O Vac type) bag for heat processing. Because the meat product is vacuumed packaged in an impervious package, the source and type of heat is optional—it can be a dry oven, steam or hot water. The products are then chilled with air or refrigerated water. After chilling, the products are virtually sterile until the vacuum packages. Since the products are virtually sterile, they can stored in a refrigerated state for up to nine months.

When refrigerated products are needed for sale, the vacuum packages and the smoke impregnated stockinets are removed. The naked products are then exposed to a high velocity hot air treatment for a minimum of 10 seconds with the air temperature being maintained within the range of 300 to 400 degrees F. The hot air treatment is critical to attain the desired color set. The products are then ready for final packaging and distribution.

From the foregoing summary, it can be seen that a primary objective of the present invention is to provide a process for significantly extending the shelf life of meat products.

Another objective of the present invention is to eliminate the possibility of bacteria developing and spoiling the finished products.

Still another objective of the present invention is to provide a high velocity hot air treatment to the meat products when they are removed from the vacuum packages and stockinets so that a desired color can be attained.

Yet another objective of the present invention is to eliminate the need for traditional, capital intensive thermal heat processing ovens normally used for smoking meat products.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention, which is measured by its claims, nor to limit its scope in any way.

Thus, the objects of the invention set forth above, along with the various features of novelty which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views. The drawings are included to provide a further understanding of the invention and are incorporated in and constitute a part of this specification. They illustrate embodiments of the invention and, together with their description, serve to explain the principles of the invention.

### BRIEF DESCRIPTION OF THE DRAWINGS

FIG. 1 is a block diagram of the present invention showing the inventory producing portion; and

FIG. 2 is a block diagram of the present invention showing the product coloring and order filling portion.

### DETAILED DESCRIPTION OF THE PREFERRED EMBODIMENT

The invention is broadly directed to various meat products that are traditionally canned or preserved in a non-frozen state including, but not limited to hams, turkey breasts, beef and pork roasts, sliced sandwich meats and a variety of seafoods. For purposes of explanation, reference will likely be made to processing hams with no intention of restricting the process to that specific meat category.

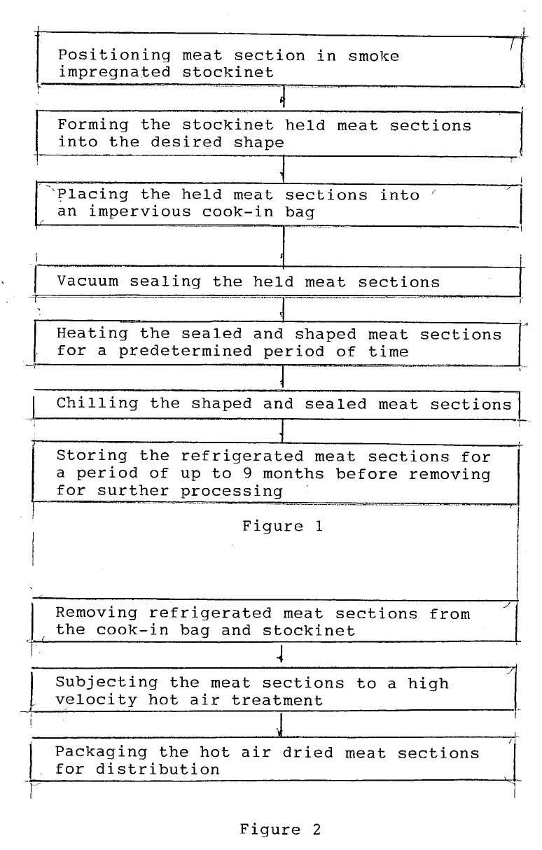

Referring now to the drawings and particularly to FIG. 1, that portion of the overall process up to and including storing the refrigerated meat sections for a period of time is generally shown as a first block diagram 10. The boneless ham muscles yielded by deboning bone-in hams are preferably placed in smoke impregnated stockinets where they can be formed and shaped in a desired configuration, usually the shape of a natural bone-in ham of a reduced size.

FIG. 2 is a second block diagram 12 showing the second part of the overall process commencing with removing the refrigerated meat sections from the cook-in bags and stockinets, then to the high velocity hot air treatments and finally to the final packing and distribution stage. The temperature of high velocity hot air is between 300 to 400 degrees F., and the air flow velocity ranges from 10 feet per second to 25 feet per second.

The invention has been described in an illustrative manner, and it is to be understood that the terminology which has been used is intended to be in the nature of words of description rather than of limitation.

Obviously, many modifications and variations of the present invention are possible in light of the teachings set forth above. It is, therefore, to be understood that within the scope of the appended claims, the invention may be practiced otherwise than as specifically described.

What is claimed is:

1. A process for extending the shelf life of meat products comprising the steps of: positioning boneless meat sections in a smoke impregnated stockinet; forming the stockinet held meat sections into the desired shape; placing the shaped and stockinet held meat sections into an impervious cook-in bag; vacuum sealing the shaped and held meat sections within the bag; heating the sealed and shaped meat sections for a predetermined period of time; chilling the sealed and shaped meat sections until the meat sections reach a refrigerated state; and storing the refrigerated meat sections for a period of up to nine months before removing for additional processing and consumption.

2. The process as claimed in claim 1 further comprising the steps of: removing the refrigerated meat sections from the cook-in bag; exposing the meat sections to a high velocity hot air treatment for at least 10 seconds at a temperature of at least 300 degrees F. to attain the desired color; and packaging the colored meat sections for distribution.

3. The process as claimed in claim 2 wherein the hot air treatment temperature is within the range of from 300 to 400 degrees F.

4. The process as claimed in claim 2 wherein the exposure time of the meat sections to the hot air treatment is from 10 to 25 seconds.

5. The process as claimed in claim 3 wherein the exposure time of the meat sections to the hot air temperature is from 10 to 25 seconds.

6. The process as claimed in claim 1 wherein the meat sections are removed from the heat when the meat sections reach a temperature of at least 260 degrees F.

7. The process as claimed in claim 5 wherein the meat sections are removed from the heat when the meat sections reach a temperature of at least 260 degrees F.

8. A process for extending the shelf life of meat products utilizing smoke-flavored shaping devices and impervious vacuum cook-in bags comprising the steps of: positioning a quantity of boneless meat sections in smoke flavored shaping devices to form the meat sections in desired shapes; placing the shaped meat sections in cook-in bags; vacuum sealing the shaped meat sections within the bags; heating the sealed and shaped meat sections for a pre-determined period of time; chilling the sealed and shaped meat sections until the meat sections reach a refrigerated state; and storing the refrigerated meat sections for a period of up to nine months before removing the refrigerated meat sections for additional processing and consumption.

9. The process as claimed in claim 8 further comprising the steps of: removing the refrigerated meat sections from the cook-in bags; subjecting the meat sections to a high velocity hot air treatment for at least 10 seconds at a temperature of at least 300 degrees F. to attain the desired meat section color; and packaging the colored meat sections for distribution.

10. The process as claimed in claim 9 wherein the hot air treatment temperature is within the range of from 300 to 400 degrees F., the exposure time of the meat sections to the hot air treatment is from 10 to 25 seconds and the meat sections are removed from the heat when the meat sections reach a temperature of at least 360 degrees F.

11. The process as claimed in claim 1 wherein the meat products include ham.

12. The process as claimed in claim 2 wherein the meat products include ham.

13. The process as claimed in claim 8 wherein the meat products include ham.

14. The process as claimed in claim 13 wherein the meat products include ham.

15. The process as claimed in claim 2 wherein the hot air velocity is at least 90 feet per second.

16. the process as claimed in claim 9 wherein the hot air velocity is at least 90 feet per second.
